(19) United States
(12) Patent Application Publication
(10) Pub. No.: US 2026/0172339 A1
(43) Pub. Date: Jun. 18, 2026

(54) Instantiation of Point-to-Multipoint Tree for Multicast Network Traffic

(71) Applicant: Arista Networks, Inc., Santa Clara, CA (US)

(72) Inventors: Sandeep Betha, Burnaby (CA); Dong Liang Feng, Burnaby (CA)

(21) Appl. No.: 18/984,770

(22) Filed: Dec. 17, 2024

(51) Int. Cl. H04L 45/02; H04L 12/46; H04L 45/44

(52) U.S. Cl. CPC H04L 45/04; H04L 12/4633; H04L 45/44

(57) ABSTRACT

A multicast virtual private network (MVPN) device may obtain MVPN membership information of MVPN peers. The MVPN device may delay instantiation of a point-to-multipoint tunnel to the MVPN peers for an MVPN instance until the MVPN device obtains an indication that the point-to-multipoint tunnel will be used. Upon reaching such an indication, the MVPN device may instantiate the point-to-multipoint tunnel. In such a manner, excess consumption of network resources can be reduced, as unnecessary point-to-multipoint tunnels will not be instantiated and subsequently maintained.

### BACKGROUND

This relates to network devices, such as network devices that implement multicast virtual private networks (MVPNs).

MVPN peer network devices can communicate with each other using Border Gateway Protocol to advertise MVPN network layer reachability information. The advertised MVPN network layer reachability information can be used by the MVPN peer network devices to automatically form point-to-multipoint tunnels for conveying multicast traffic.

### BRIEF DESCRIPTION OF THE DRAWINGS

FIG. 1 is a diagram of an illustrative network having network devices that handle multicast traffic in accordance with some embodiments.

FIG. 2 is a diagram of an illustrative network device in accordance with some embodiments.

FIG. 3 is a diagram of illustrative multicast virtual private network devices exchanging route advertisements in accordance with some embodiments.

FIG. 4 is a diagram of an illustrative network device configured to instantiate a point-to-multipoint tunnel based on an indication of expected tunnel use in accordance with some embodiments.

FIG. 5 is a diagram of illustrative network devices configured to implement a point-to-multipoint tunnel in accordance with some embodiments.

FIG. 6 is a diagram of an illustrative network device configured to obtain multicast virtual private network membership information without instantiating a corresponding point-to-multipoint tunnel in accordance with some embodiments.

FIG. 7 is a flowchart of illustrative operations for instantiating a point-to-multipoint tunnel in accordance with some embodiments.

### DETAILED DESCRIPTION

A network can convey network traffic (e.g., in the form of frames, packets, and/or other formats) between hosts. To properly forward the network traffic, the network can include a number of network devices. In illustrative configurations described herein as examples, some of these network devices may implement multicast virtual private networks (MVPNs) and may exchange network layer reachability information including MVPN route information with one another and process the exchanged information. These network devices are sometimes referred to as MVPN network devices, MVPN devices, or MVPN speakers.

Configurations in which the exchange of MVPN route information occurs using Border Gateway Protocol, or more specifically Multiprotocol Border Gateway Protocol, and/or with Multiprotocol Label Switching tunneling technology (e.g., using Multiprotocol Label Switching network infrastructure) are sometimes described herein as illustrative examples. If desired, the exchange of network layer reachability information can occur with other control plane routing protocols and/or utilizing other types of network overlay infrastructure (e.g., Virtual Extensible Local Area Network tunneling or overlay).

In one illustrative network configuration, a set of MVPN devices may be coupled between a network traffic source and multiple network traffic receivers. The set of MVPN network devices may be configured to instantiate (e.g., form) a point-to-multipoint tunnel to distribute (e.g., multicast) the traffic from the source to the multiple receivers.

To provide automation and speed up the formation of point-to-multipoint tunnels, MVPN devices can often instantiate the point-to-multipoint tunnels automatically when MVPN membership information is obtained (e.g., when MVPN peers are identified via received advertisement messages). However, (automatically) instantiating all (possible) the point-to-multipoint tunnels in this manner can, in some scenarios, consume excess network resources (e.g., MVPN device computational resources, network traffic bandwidth, etc.). As examples, headend or root MVPN devices of some instantiated point-to-multipoint tunnels may not be coupled to appropriate multicast traffic sources, tailend or leaf MVPN devices of some instantiated point-to-multipoint tunnels may not be coupled to appropriate multicast traffic receivers, and/or, more generally, some instantiated point-to-multipoint tunnels may not actually be used to convey multicast traffic (i.e., remain unused after construction). Accordingly, the point-to-multipoint tunnels instantiated in these examples may be unnecessary and wasteful.

To more efficiently instantiate (e.g., generate or form, configure, etc.) point-to-multipoint tunnels, MVPN devices may be configured to identify indications that corresponding point-to-multipoint tunnels are expected to be used and may instantiate the corresponding point-to-multipoint tunnels in response to these identified indications of expected use. As such, while MVPN membership information is maintained for MVPN peers of each MVPN device, only membership information of those MVPN peers that are expected to receive multicast traffic from a given MVPN device will cause the corresponding point-to-multipoint tunnel from the given MVPN device to those MVPN peers to be instantiated.

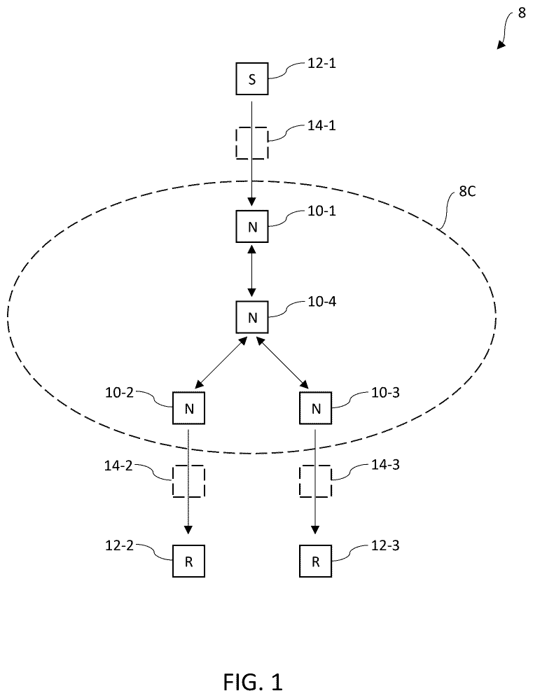

An illustrative network 8 in which network devices are configured to form one or more multicast virtual private networks (e.g., implemented using one or more corresponding point-to-multipoint tunnels) is shown in FIG. 1. In particular, network 8 may be of any suitable scope and/or form part of a larger network of any suitable scope. As examples, network 8 may include, be, and/or form part of one or more local segments, one or more local subnets, one or more local area networks, one or more campus area networks, one or more metropolitan area networks, one or more wide area networks, one or more datacenter networks, one or more cloud networks, etc. Network 8 may include any suitable number of different network devices that are communicatively coupled to each other and to corresponding end hosts of network 8.

In general, network 8 may include one or more wired network portions with network devices communicatively coupled to one another using wired technologies or standards such as Ethernet (e.g., using copper cables and/or fiber optic cables). If desired, network 8 may include one or more wireless network portions implemented by wireless access points (e.g., to form wireless local area networks). If desired, network 8 may include internet service provider networks (e.g., the Internet) or other public service provider networks, private service provider networks (e.g., Multiprotocol Label Switching networks), and/or may include other types of networks such as telecommunication service provider networks.

In the illustrative example of FIG. 1, network 8 may include a core network or core network portion 8C interconnecting different edge networks or edge network portions (e.g., different sites and/or different domains). As one illustrative example, core network portion 8C may include or form a backbone network such as one or more service provider networks (e.g., Internet or Internet Protocol service provider networks, Multiprotocol Label Switching infrastructure networks, cloud provider networks, or generally a communication network core). Core network portion 8C may communicatively couple different edge network portions belonging to entities (e.g., customers) different from (or the same as) those that manage core network portion 8C. In configurations in which network devices implement one or more MVPN instances over core network portion 8C, core network portion 8C may sometimes be referred to as an MVPN core or generally an underlay network (for MVPN).

Core network 8C may include edge network devices, such as network devices 10-1, 10-2, and 10-3, which may sometimes be referred to as provider (network) edge devices. Core network 8C may also include core network devices, such as device 10-4, which are sometimes referred to as provider (network) core devices. The provider core devices may be communicatively coupled to one another and to provider edge devices within core portion 8C. The provider edge devices may serve as interfacing devices of core network 8C and the corresponding edge network portions attached to core network 8C (via the provider edge devices). These edge network portions (e.g., each representing a different site, a different domain, a different edge network, etc.) may each include its own set of hosts and its own set of network devices between its hosts and one or more corresponding provider edge devices.

In the example of FIG. 1, network device 10-1 in core network 8C may be communicatively coupled to a first edge network portion (e.g., a first customer edge network) of network 8 containing end host 12-1. In some illustrative configurations, one or more intervening (customer) network devices may be communicatively coupled between provider edge device 10-1 and host 12-1. Some of these intervening (customer) network devices (e.g., network device 14-1) may be directly attached to provider edge devices (e.g., device 10-1), and may sometimes be referred to as customer edge devices.

In an analogous manner, network device 10-2 in core network 8C may be communicatively coupled to a second edge network portion (e.g., a second customer edge network) of network 8 containing end host 12-2. In some illustrative configurations, one or more intervening (customer) network devices, such as device 14-2, may be communicatively coupled between network device 10-2 and host 12-2. Network device 10-3 in core network 8C may be communicatively coupled to a third edge network portion (e.g., a third customer edge network) of network 8 containing end host 12-3. In some illustrative configurations, one or more intervening (customer) network devices, such as device 14-3, may be communicatively coupled between network device 10-3 and host 12-3.

Provider core devices such as device 10-4 may facilitate communication between devices 10-1, 10-2, and 10-3. Consequently, provider core and edge network devices in core network 8C may facilitate communication between the edge network portions attached to the provider edge (e.g., devices 10-1, 10-2, and 10-3).

Network devices in network 8 (e.g., network devices 10-1, 10-2, 10-3, 10-4, 14-1, 14-2, and 14-3 and other network devices in core network 8C and in edge networks) may each include or be a switch (e.g., a single-layer (Layer 2) switch or a multi-layer (Layer 2 and Layer 3) switch), a bridge, a router, a gateway, a hub, a repeater, a firewall, a wireless access point, a network device serving other networking functions, a management device that controls the operation of one or more of other network devices, a network device that includes the functionality of two or more of these devices, and/or other types of network devices. Configurations in which network devices 10-1, 10-2, 10-3, 10-4, 14-1, 14-2, and 14-3 are (multi-layer) switches, routers, gateways, or network devices that generally include routing functionalities (e.g., implement routing protocols) are described herein as an illustrative example.

Hosts such as end hosts 12-1, 12-2, and 12-3 may be implemented on respective host (computing) equipment. Host equipment in network 8 (e.g., implementing hosts serving as end hosts of network 8 in an edge network portion or a site) may include or be a computer, a server (e.g., server computing equipment), a portable electronic device such as a cellular telephone, a laptop, etc., a network traffic storage device, a networking service or analysis device, network management equipment that manages and controls the operation of one or more of hosts and/or network devices, and/or any other suitable types of specialized or general-purpose host computing equipment, e.g., running one or more client-side and/or server-side applications.

In some configurations described herein as illustrative examples, network devices 10-1, 10-2, and 10-3 (and generally network devices of core network 8C) may implement one or more MVPN instances over core network 8C, and accordingly, may be referred to as MVPN peer devices with respect to each other. In these illustrative configurations, the MVPN peer devices may exchange MVPN route information (e.g., network layer reachability information) with one another over core network 8C. The MVPN route information (e.g., advertisement messages containing the MVPN route information) may be exchanged based on any suitable underlying (transport layer and internet layer) protocol(s) that facilitate communication across core or underlay network 8C. Underlay network 8C (and the devices herein) may provide and implement underlying infrastructure over which the overlay Multiprotocol Label Switching-based network (or the overlay Virtual Extensible Local Area Network-based network) is implemented.

While network layer reachability information may be exchanged based on any suitable routing protocol, arrangements in which MVPN peer devices such as devices 10-1, 10-2, 10-3, 10-4 exchange network layer reachability information with one another using Border Gateway Protocol, or more specifically Multiprotocol Border Gateway Protocol, are described herein as an illustrative example. In these arrangements, devices 10-1, 10-2, 10-3, 10-4 may sometimes be referred to as Border Gateway Protocol and/or MVPN speakers (e.g., configured to advertise and process corresponding advertised Border Gateway Protocol messages containing MVPN route information). The use of Border Gateway Protocol with a Multiprotocol Label Switching overlay network to implement the exchange of MVPN route information is merely illustrative. If desired, other routing protocols (or generally other control plane protocols) and/or other types of overlay network infrastructure may be used to facilitate the exchange of MVPN route information between MVPN peer devices, or more generally the exchange of network layer reachability information between network devices in network 8.

As one illustrative example shown in FIG. 1, end host 12-1 may serve as a source of network traffic, while end hosts 12-2 and 12-3 may serve as receivers (e.g., destinations) of the network traffic. Accordingly, in this example, network devices 10-1, 10-2, and 10-3 may be configured to provide a MVPN instance with which traffic from source host 12-1 can be distributed (e.g., multicast) to receiver hosts 12-2 and 12-3 (e.g., through the devices of core network 8C in corresponding devices in respective edge networks). In illustrative configurations described herein as an example, the MVPN instance may be implemented using a point-to-multipoint tunnel (e.g., a point-to-multipoint tree with network device 10-1 as the root device of the tree and network devices 10-2 and 10-3 as leaf devices of the tree).

Configurations in which devices 10-1, 10-2, 10-3, and 10-4 are implemented in the context of a provider or core network 8C are described herein as an illustrative example. If desired, devices 10-1, 10-2, 10-3, and 10-4 implemented in other suitable network contexts (e.g., implemented separately from a core network). The embodiments described herein may similarly be applicable to these network devices when implemented in the other network contexts. For example, these network devices when implemented in the other network contexts may be configured to provide MVPNs between source hosts and receiver hosts for conveying multicast traffic.

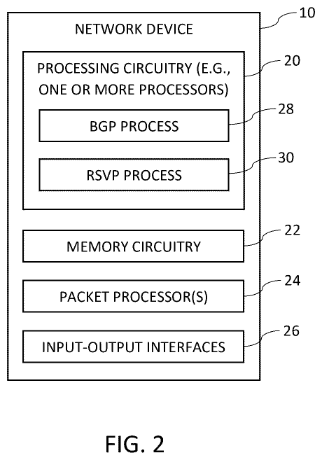

FIG. 2 is a diagram of an illustrative network device 10, instance(s) of which may be used to implement one or more (e.g., all) of network devices 10-1, 10-2, 10-3, and 10-4 in FIG. 1. As shown in FIG. 2, a network device 10 (e.g., device 10-1, 10-2, 10-3, or 10-4 in FIG. 1) may include processing circuitry 20, memory circuitry 22, one or more packet processors 24, and input-output interfaces 26 (sometimes referred to as network interfaces) mounted on and/or within a housing or chassis of network device 10. In one illustrative arrangement, network device 10 may be or form part of a modular network device system (e.g., a modular switch system having removably coupled modules usable to flexibly expand characteristics and capabilities of the modular switch system such as to increase the number of ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 20 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 20 may run (e.g., execute) a network device operating system and/or other software (including firmware) that is stored on memory circuitry 22. Memory circuitry 22 may include one or more non-transitory (tangible) computer-readable storage media that store the operating system software and/or any other software code, sometimes referred to as program instructions, software, data, instructions, or code. As an example, the operations associated with the advertisement and processing of MVPN route information and/or the instantiation of point-to-multipoint tunnels performed by network device 10 as described herein may be stored as (software) instructions on the one or more non-transitory computer-readable storage media (e.g., in portion(s) of memory circuitry 22). The corresponding processing circuitry (e.g., one or more processors of processing circuitry 20) may process or execute the respective instructions to perform the operations associated with the advertisement and processing of MVPN route information and/or the configuration of point-to-multipoint tunnels.

Memory circuitry 22 may include non-volatile memory (e.g., flash memory, electrically-programmable read-only memory, a solid-state drive, hard disk drive storage, etc.), volatile memory (e.g., static random-access memory or dynamic random-access memory), removable storage devices (e.g., storage devices removably coupled to device 10), and/or other types of memory circuitry. Processing circuitry 20 and (at least a portion of) memory circuitry 22 as described above may sometimes be referred to collectively as control circuitry (e.g., implementing a control plane) for network device 10. Accordingly, processing circuitry 20 may sometimes be referred to as control plane processing circuitry 20.

As just a few examples, processing circuitry 20 may execute network device control plane software such as operating system software, routing policy management software, routing protocol or other protocol processes (e.g., a border gateway protocol (BGP) process, a resource reservation protocol (RSVP) process etc.), routing information base processes, and other control software, may be used to support the operation of protocol clients and/or servers (e.g., to form some or all of a communications protocol stack), may be used to support the operation of packet processor(s) 24, may store packet forwarding information, may execute packet processing software, and/or may execute other software instructions that control the functions of network device 10 and the other components therein.

Packet processor(s) 24 may be used to implement a data plane or forwarding plane of network device 10. Accordingly, packet processor(s) 24 may sometimes be referred to as data plane processing circuitry 24. Packet processor(s) 24 may include one or more processors such as application specific integrated circuit (ASIC) processors, application specific system processors (ASSPs), programmable logic devices (e.g., field programmable gate array (FPGA) devices), microprocessors, central processing units (CPUs), graphics processing units (GPUs), general-purpose processors, host processors, microcontrollers, digital signal processors, and/or other types of processors.

Packet processor 24 may receive incoming network traffic via input-output interfaces 26, parse and analyze the network traffic, process the network traffic based on packet forwarding decision data (e.g., in a forwarding information base) and/or in accordance with network protocol(s) or other forwarding policy, and forward (or drop) the network traffic accordingly. The packet forwarding decision data may be stored on memory circuitry integrated as part of and/or separate from packet processor 24 (e.g., on content-addressable memory), and/or on a portion of memory circuitry 22. Memory circuitry for packet processor 24 may include volatile memory and/or non-volatile memory.

Input-output interfaces 26 may include one or more different types of communication interfaces such as Ethernet interfaces, optical interfaces, network layer (e.g., Internet Protocol such as Internet Protocol version 4 and/or Internet Protocol version 6) interfaces, wireless interfaces such as wireless personal area network interfaces and wireless local area network interfaces, and/or other communication interfaces for connecting network device 10 to the Internet, a local area network, a wide area network, a mobile network, and/or generally other network device(s), peripheral devices, and computing equipment (e.g., host computing equipment). In illustrative configurations described herein as an example, input-output interfaces 26 may include Ethernet interfaces implemented using and therefore including (Ethernet) ports. In particular, data link layer interface circuitry may be coupled to the ports to form Ethernet interfaces with the desired interface configurations. Processing circuitry 20 may further form (e.g., configure) network layer and/or other higher layer interfaces. The ports may be physically coupled and electrically connected to corresponding mating connectors of external equipment, when received at the ports, and may have different form-factors to accommodate different cables, different modules, different devices, or generally different external equipment.

Device 10 may include any suitable number of other components such as power management circuitry, thermal management components (e.g., heatsinks, fans, etc.), etc. In general, the components of device 10 may be communicatively coupled to each other, or at least to processing circuitry 20 and/or memory circuitry 22, via corresponding signal paths. These signal paths may be configured to convey power (e.g., supply voltage(s)), control signals, data, and/or other information between the inter-coupled components of device 10.

In configurations in which network device 10 implements an MVPN instance with MVPN peer devices, processing circuitry 20 on network device 10 may execute a border gateway protocol process 28 (sometimes referred to as border gateway protocol agent 28). Border gateway protocol process 28 may perform operations for implementing a border gateway protocol (BGP) that is in accordance with or is compatible with the Border Gateway Protocol (e.g., as defined by one of more of the Request for Comments (RFCs) associated with the Border Gateway Protocol) or other standardized version(s) of border gateway protocol(s), that includes extensions and/or modifications to standardized version(s) of border gateway protocol(s), that is in accordance with or generally compatible with proprietary version(s) of border gateway protocol(s), and/or that generally specifies operations that manage and facilitate the exchange of network layer routing information (e.g., MVPN route information) with other peer devices and operations that handle and process the exchanged network layer routing information.

In some illustrative configurations sometimes described herein as an example, BGP process 28 may manage and facilitate operations for the exchanging MVPN routes (e.g., MVPN route information contained in advertised messages) with other MVPN peer devices and the handling and processing of the exchanged information. The operations associated with the management of MVPN instances may be implemented as part of BGP process 28 executing on processing circuitry 20, or if desired, may be implemented as part of a different (MVPN) process separate from BGP process 28 (e.g., both executing on processing circuitry 20).

In illustrative configurations described herein as an example, processing circuitry 20 on device 10 may also execute a resource reservation protocol process 30 (sometimes referred to as resource reservation protocol agent 30). Resource reservation protocol process 30 may perform operations for implementing a resource reservation protocol (RSVP) that is in accordance with or is compatible with the Resource Reservation Protocol (e.g., as defined by RFC 2205) or other standardized version(s) of resource reservation protocol(s), that includes extensions and/or modifications to standardized version(s) of resource reservation protocol(s), that is in accordance with or generally compatible with proprietary version(s) of resource reservation protocol(s), and/or that generally specifies operations that manage and facilitate the signaling for setting up and tearing down point-to-multipoint tunnels (e.g., point-to-multipoint trees or paths) for implementing MVPN instances and the maintenance (e.g., refreshing, error handling, etc.) of these point-to-multipoint tunnels.

While illustrative configuration in which a resource reservation protocol is used to provide the mechanism by which point-to-multipoint tunnels for MVPN instances are implemented are sometimes described herein as an example, this example is merely illustrative. If desired, other mechanism(s) (e.g., ingress replication at the ingress edge device of core network 8C, a label distribution protocol (LDP), etc.) may be used in addition to or instead of the resource reservation protocol to implement point-to-multipoint tunnels for MVPN instances.

While RSVP process 30 and BGP process 28 are sometimes described herein to perform parts of the RSVP, BGP, and MVPN operations for device 10, this is merely illustrative. Processing circuitry 20 may be organized in any suitable manner (e.g., to have other processes or agents instead of or in addition to a RSVP process 30, a BGP process 28, etc.) to perform different parts of the RSVP, BGP, and MVPN operations described herein. Accordingly, processing circuitry 20 (or the control circuitry of device 10 formed therefrom) may sometimes be described herein to perform the RSVP, BGP, and MVPN operations described herein instead of specifically referencing one or more agents, processes, and/or the kernel executed by processing circuitry 20.

Configurations in which network devices 10-1, 10-2, and 10-3 (and device 10-4) in FIG. 1 each execute a BGP process 28 (e.g., on respective processing circuitry 20 of each of these network devices 10) and in which network devices 10-1, 10-2, 10-3, and 10-4 in FIG. 1 each execute a RSVP process 30 (e.g., on respective processing circuitry 20 of each of these network devices 10) are sometimes described herein as an illustrative example.

In particular, processing circuitry 20 of each of at least network devices 10-1, 10-2, and 10-3 may perform operations based on a border gateway protocol (e.g., when executing process 28). As part of these operations, processing circuitry 20 of each of network devices 10-1, 10-2, and 10-3 may transmit route advertisement messages to and receive route advertisements from other BGP peer devices, e.g., to facilitate the exchange of network layer reachability information.

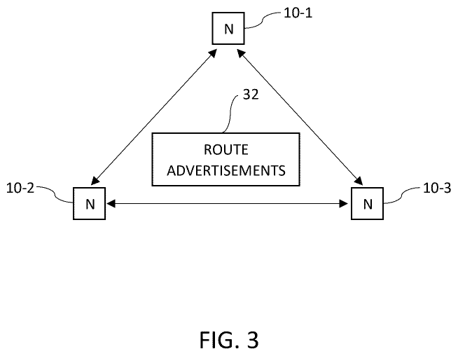

FIG. 3 is a diagram of illustrative network devices 10-1, 10-2, and 10-3 (e.g., as described in connection FIG. 1) configured to exchange route information with one another. In the example of FIG. 3, network device 10-1 (e.g., processing circuitry 20 of device 10-1, when executing BGP process 28) may generate and advertise (e.g., transmit) network layer reachability information in the form of routes in corresponding route advertisements 32 (sometimes referred to as route advertisement messages 32) to peer network devices such as devices 10-2 and 10-3. Remote peer devices such as devices 10-2 and 10-3 (e.g., corresponding processing circuitry 20 thereof, when executing BGP process 28) may receive and process the advertised route information in advertisements messages 32 from device 10-1.

In particular, advertisements messages 32 from device 10-1 may include messages containing MVPN membership information (e.g., as network layer reachability information), indicating device 10-1 as a MVPN speaker and a member or participant of an MVPN. The receiving devices 10-2 and 10-3 (e.g., corresponding processing circuitry 20 thereof) may obtain and store the MVPN membership information of device 10-1 as advertised in messages 32. In some illustrative configurations described herein as examples, the MVPN membership information of device 10-1 may be usable by device 10-2 (e.g., processing circuitry 20 thereof) to generate a point-to-multipoint tunnel from device 10-2 to device 10-1, as one leaf or tailend device of the tunnel and may be usable by device 10-3 (e.g., processing circuitry 20 thereof) to generate a point-to-multipoint tunnel from device 10-3 to device 10-1, as one leaf or tailend device of the tunnel.

In the example of FIG. 3, network device 10-2 (e.g., processing circuitry 20 of device 10-2, when executing BGP process 28) may generate and advertise (e.g., transmit) network layer reachability information in the form of routes in corresponding advertisement messages 32 to peer network devices such as devices 10-1 and 10-3. Remote peer devices such as devices 10-1 and 10-3 (e.g., corresponding processing circuitry 20 thereof, when executing BGP process 28) may receive and process the advertised route information in advertisements messages 32 from device 10-2.

In particular, advertisements messages 32 from device 10-2 may include messages containing MVPN membership information (e.g., as network layer reachability information), indicating device 10-2 as a MVPN speaker and a member or participant of the MVPN. The receiving devices 10-1 and 10-3 (e.g., corresponding processing circuitry 20 thereof) may obtain and store the MVPN membership information of device 10-2 as advertised in messages 32. In some illustrative configurations described herein as examples, the MVPN membership information of device 10-2 may be usable by device 10-1 (e.g., processing circuitry 20 thereof) to generate a point-to-multipoint tunnel from device 10-1 to device 10-2, as one leaf or tailend device of the tunnel and may be usable by device 10-3 (e.g., processing circuitry 20 thereof) to generate a point-to-multipoint tunnel from device 10-3 to device 10-2, as one leaf or tailend device of the tunnel.

In the example of FIG. 3, network device 10-3 (e.g., processing circuitry 20 of device 10-3, when executing BGP process 28) may generate and advertise (e.g., transmit) network layer reachability information in the form of routes in corresponding advertisement messages 32 to peer network devices such as devices 10-1 and 10-2. Remote peer devices such as devices 10-1 and 10-2 (e.g., corresponding processing circuitry 20 thereof, when executing BGP process 28) may receive and process the advertised route information in advertisements messages 32 from device 10-3.

In particular, advertisements messages 32 from device 10-3 may include messages containing MVPN membership information (e.g., as network layer reachability information), indicating device 10-3 as a MVPN speaker and a member or participant of the MVPN. The receiving devices 10-1 and 10-2 (e.g., corresponding processing circuitry 20 thereof) may obtain and store the MVPN membership information of device 10-3 as advertised in messages 32. In some illustrative configurations described herein as examples, the MVPN membership information of device 10-3 may be usable by device 10-1 (e.g., processing circuitry 20 thereof) to generate a point-to-multipoint tunnel from device 10-1 to device 10-3, as one leaf or tailend device of the tunnel and may be usable by device 10-2 (e.g., processing circuitry 20 thereof) to generate a point-to-multipoint tunnel from device 10-2 to device 10-3, as one leaf or tailend device of the tunnel.

When advertisement messages 32 are conveyed in accordance with BGP (e.g., Border Gateway Protocol as specified in RFC 6513 and RFC 6514), the messages 32 containing MVPN membership information may be BGP messages containing MVPN (i.e., MCAST-VPN) Auto-Discovery (A-D) routes, such as MVPN Intra-Autonomous-System (Intra-AS) Inclusive Provider Multicast Service Interface (I-PMSI) A-D routes (sometimes referred to as MVPN type 1 routes) as specified in RFC 6514, as the network layer reachability information in messages 32 (e.g., BGP messages).

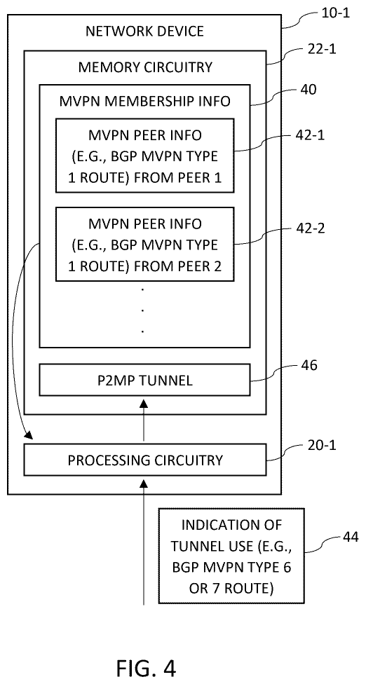

Based on the operations described in connection with FIG. 3, each of network devices 10-1, 10-2, and 10-3 may identify the other two network devices (and, in a similar manner, other MVPN peer devices) as participating in a MVPN and accordingly store MVPN membership of the other two network devices (and other MVPN peer devices). FIG. 4 is a diagram of an illustrative network device 10, such as network devices 10-1 as described in connection with FIGS. 1-3. As shown in FIG. 4, processing circuitry 20 of device 10-1 (i.e., processing circuitry 20-1 in FIG. 4) may maintain MVPN membership information 40, for a given MVPN instance, on memory circuitry 22 of device 10-1 (i.e., memory circuitry 22-1 in FIG. 4). The maintained MVPN membership information 40 may include information 42-1 for a first MVPN peer, information 42-2 for a second MVPN peer, and/or additional information for additional MVPN peer(s) for the MVPN instance.

In the example of FIG. 4, processing circuitry 20-1 (e.g., when executing BGP process 28) may receive a first advertisement message (e.g., a first message 32 in FIG. 3) from a first peer device (e.g., device 10-2) containing MVPN membership information for the first peer device. In some illustrative configurations described as an example, processing circuitry 20-1 may receive, from device 10-2, a BGP message 32 containing a MVPN type 1 route as the network layer reachability information. The information in the MVPN type 1 route may include the MVPN membership information for the first peer device. Accordingly, processing circuitry 20-1 may obtain the MVPN peer information 42-1 for the first peer device from the received first advertisement message and store the obtained information 42-1 for the first peer device as part of MVPN membership information 40 for the MVPN instance.

Similarly, processing circuitry 20-1 (e.g., when executing BGP process 28) may receive a second advertisement message (e.g., a second message 32 in FIG. 3) from a second peer device (e.g., device 10-3) containing MVPN membership information for the second peer device. In some illustrative configurations described as an example, processing circuitry 20-1 may receive, from device 10-3, a BGP message 32 containing a MVPN type 1 route as the network layer reachability information. The information in the MVPN type 1 route may include the MVPN membership information for the second peer device. Accordingly, processing circuitry 20-1 may obtain the MVPN peer information 42-2 for the second peer device from the received second advertisement message and store the obtained information 42-2 for the first peer device as part of MVPN membership information 40 for the MVPN instance.

Based on receiving any MVPN membership information (e.g., in advertisement messages from MVPN peer(s)) for the MVPN instance, processing circuitry 20-1 could automatically instantiate a point-to-multipoint tunnel from device 10-1 (as the root or headend network device) to the one or more MVPN peer devices (as the leaf or tailend network devices). However, doing so may risk the instantiated point-to-multipoint tunnel not being useful (e.g., not being used to convey multicast traffic).

Accordingly, processing circuitry 20-1 may delay the instantiation of the point-to-multipoint tunnel for an indefinite amount of time, until processing circuitry 20-1 determines that such an instantiated point-to-multipoint tunnel will be used to convey multicast traffic. In particular, processing circuitry 20-1 may make such a determination based on obtaining (e.g., receiving) an indication 44 of expected or anticipated tunnel use. More specifically, indication 44 may be an indication of anticipated conveyance of multicast traffic to a given leaf network device of the point-to-multipoint tunnel. In illustrative configurations sometimes described herein as an example, certain types of advertisement messages 32 (e.g., other than those containing MVPN membership information) may serve as and contain indication 44 of expected (or anticipated) tunnel use.

Referring back to FIG. 3, in addition to generating, transmitting, receiving, and/or processing advertisement messages 32 containing MVPN membership information, network devices 10-1, 10-2, and/or 10-3 (e.g., processing circuitry 20 thereof, when executing BGP process 28) may sometimes (e.g., depending on the operational scenario and/or network configuration) generate, transmit, receive, and/or process MVPN tree join route information in advertisement messages 32. In particular, MVPN tree join routes (e.g., shared tree join routes or source tree join routes) in advertisement messages 32 may indicate a particular MVPN tree (e.g., for implementing a point-to-multipoint tunnel) to join. When advertisement messages 32 are conveyed in accordance with BGP (e.g., Border Gateway Protocol as specified in RFC 6513 and RFC 6514), the messages 32 containing MVPN tree join route information may be BGP messages containing MVPN (i.e., MCAST-VPN) Customer Multicast (C-Multicast) routes, such as MVPN Shared Tree Join routes (sometimes referred to as MVPN type 6 routes) and Source Tree Join routes (sometimes referred to as MVPN type 7 routes) as specified in RFC 6514, as the network layer reachability information in messages 32 (e.g., BGP messages).

Accordingly, these tree join routes (e.g., an MVPN type 6 route or an MVPN type 7 route in a BGP message 32), when received by processing circuitry 20-1 (FIG. 4) in corresponding advertisement messages 32, may serve as an indication that there is at least one receiver interested in the multicast flow (e.g., the receiver attached to the network device that originated the advertisement message 32 containing the tree join route). Consequently, these tree join routes may serve as indication 44 in FIG. 4 that the point-to-multipoint tunnel, when instantiated, will be used (e.g., to convey traffic to at least one interested receiver).

Some network devices in core network 8C may receive and process shared tree join routes (e.g., MVPN type 6 routes), while other network devices in core network 8C may not receive or process shared tree join routes. As an example, when device 10-1 is configured (e.g., serves) as a rendezvous point network device for a MVPN, processing circuitry 20-1 of device 10-1 may receive and process shared tree join routes (e.g., MVPN type 6 routes) for the MVPN. In particular, device 10-1, serving as the rendezvous point network device, may perform the operations described in connection with FIG. 4 using a received shared tree join route as indication 44 to instantiate the tunnel corresponding to the shared tree.

Some network devices in core network 8C may receive and process source tree join routes (e.g., MVPN type 7 routes), while other network devices in core network 8C may not receive or process source tree join routes. As an example, when device 10-1 is configured (e.g., serves) as a sender (provider edge) network device for a source (e.g., source host 12-1 in FIG. 1), processing circuitry 20-1 of device 10-1 may receive and process source tree join routes (e.g., MVPN type 7 routes) for the MVPN. In particular, device 10-1, serving as the sender network device (e.g., the provider edge network device attached to the source), may perform the operations described in connection with FIG. 4 using a received source tree join route as indication 44 to instantiate the tunnel corresponding to the source tree.

If desired, a network device such as network device 10-1 may be configured as both a rendezvous point network device and a sender provider edge network device. Accordingly, network device 10-1 may receive either or both of shared tree join routes or source tree join routes.

The use of tree join route information as indication 44 is merely illustrative. If desired, other types of indications may be used instead of or in addition to tree join route information as indication 44.

As shown in FIG. 4, upon obtaining indication 44 (e.g., an MVPN type 6 route or an MVPN type 7 route in a BGP message 32), processing circuitry 20-1 may instantiate a point-to-multipoint (P2MP) tunnel for the MVPN instance based on membership information 40. In particular, upon receiving indication 44, processing circuitry 20-1 may generate, as part of the tunnel instantiation operation and based on membership information 40, point-to-multipoint tunnel (state) information 46 that defines and is used to implement the point-to-multipoint tunnel and may store the generated information 46 on memory circuitry 22-1. As one example, processing circuitry 20-1 may store information 46 as part of (e.g., as an entry for a particular MVPN instance in) a tree information base in memory circuitry 22-1.

Information 46 for the point-to-multipoint tunnel may identify device 10-1 as the root or headend network device and the MVPN peer devices of the MVPN instance as the leaf or tailend network devices, may identify downstream network devices (e.g., devices 10-4, 10-2, and 10-3) through which the point-to-multipoint tunnel is implemented, may identify links, paths, tunnel identifiers, and/or other information to implement the point-to-multipoint tunnel using device-10 and using other devices in core network 8C. Thereafter, processing circuitry 20-1 may implement (e.g., cause the implementation of) the point-to-multipoint tunnel in core network 8C, as a subsequent part of the tunnel instantiation operation (following the generation of tunnel state information 46).

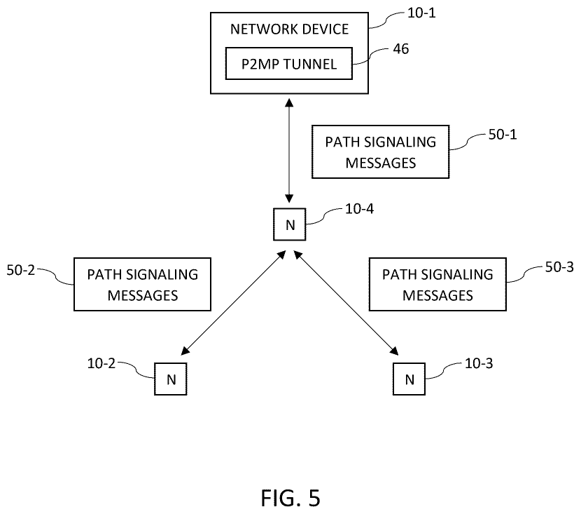

Depending on the network configuration and deployment, processing circuitry 20-1 may implement (e.g., form) the point-to-multipoint tunnel for operation in any number of desired manners. In some illustrative configurations described herein as an example, processing circuitry 20-1 of device 10-1 may perform signaling, e.g., in accordance with RSVP, to downstream devices to form paths for constructing a point-to-multipoint tunnel (e.g., a RSVP point-to-multipoint tree contain multiple label-switched paths) that implements the point-to-multipoint tunnel for operation to convey multicast traffic. FIG. 5 is a diagram of an illustrative network device 10-1 configured to signal to other network devices to form a point-to-multipoint tunnel.

As shown in FIG. 5, processing circuity 20-1 of device 10-1 may store tunnel state information 46 for the point-to-multipoint tunnel and, based on the state information, form point-to-multipoint tunnel by signaling to downstream devices such as devices 10-4, 10-2, and 10-3, to implement the desired point-to-multipoint tunnel (e.g., based on the state information 46). In the example of FIG. 5, the signaling may be performed using the conveyance of path signaling messages 50-1, 50-2, and 50-3.

In some illustrative configurations described herein as an example, processing circuitry 20-1 of device 10-1 may set up and manage the paths of the point-to-multipoint tunnel using RSVP (e.g., when executing RSVP process 30). In this example, path signaling messages 50-1, 50-2, and 50-3 may include path messages (e.g., Path messages as specified in RFC 2205) that cause each of the downstream devices 10-4, 10-2, and 10-3 to each maintain path state information (e.g., a part of state information 46) for implementing point-to-multipoint tunnel 46. In particular, the maintained path state information may implement a first path from device 10-1 to device 10-2 via device 10-4 and a second path from device 10-1 to device 10-2 via device 10-4). In addition to path messages, path signaling messages 50-1, 50-2, and 50-3 may also include reservation messages that are sent upstream to request and set up resource reservation (and acknowledge the reception of path messages), tear messages that remove state information, error messages that report errors, and/or other types of messages.

Configured and maintained in this manner, the point-to-multipoint tunnel may be implemented by paths (e.g., label-switched paths) whose state information (e.g., including tunnel identifiers such as labels) are maintained on downstream devices 10-4, 10-2, and 10-3. Accordingly, when multicast traffic (received from a source host 12-1) is sent by device 10-1 to device 10-4, the multicast traffic may be encapsulated to include the tunnel identifier (e.g., a label or another type of tunnel identifier). Subsequently, device 10-4 may receive the traffic with the tunnel identifier and, based on identifying the tunnel identifier, replicate and transmit the multicast traffic to devices 10-2 and 10-3 (e.g., based on the maintained path information for traffic with the tunnel identifier).

The use of the paths constructed in connection with FIG. 5 to implement the point-to-multipoint tunnel is merely illustrative. If desired, the point-to-multipoint tunnel may be implemented in other manners. As an illustrative example, processing circuity 20-1 may configure device 10-1 (e.g., packet processor(s) therein) to perform ingress replication to distribute received multicast traffic as separate (unicast) copies to devices 10-2 and 10-3 (via device 10-4), in order to implement the point-to-multipoint tunnel.

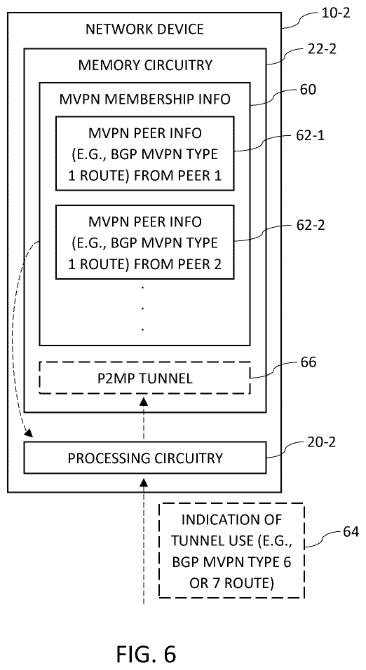

While some point-to-multipoint tunnels may be instantiated in the manner described in connection with FIGS. 4 and 5, other point-to-multipoint tunnels may not be instantiated. As an example, FIG. 6 is a diagram of an illustrative network device that does not instantiate a corresponding point-to-multipoint tunnel.

As shown in FIG. 6, processing circuitry 20 of device 10-2 (i.e., processing circuitry 20-2), e.g., when executing BGP process 28, may maintain MVPN membership information 60, for a given MVPN instance, on memory circuitry 22 of device 10-2 (i.e., memory circuitry 22-2). The maintained MVPN membership information 60 may include information 62-1 for a first MVPN peer, information 62-2 for a second MVPN peer, and/or additional information for additional MVPN peer(s) for the MVPN instance.

In the example of FIG. 6, processing circuitry 20-2 (e.g., when executing BGP process 28) may receive a first advertisement message (e.g., a first message 32 in FIG. 3) from a first peer device (e.g., device 10-1) containing MVPN membership information for the first peer device. In some illustrative configurations described as an example, processing circuitry 20-2 may receive, from device 10-1, a BGP message 32 containing a MVPN type 1 route as the network layer reachability information. The information in the MVPN type 1 route may include the MVPN membership information for the first peer device. Accordingly, processing circuitry 20-2 may obtain the MVPN peer information 62-1 for the first peer device from the received first advertisement message and store the obtained information 62-1 for the first peer device as part of MVPN membership information 60 for the MVPN instance.

Similarly, processing circuitry 20-2 (e.g., when executing BGP process 28) may receive a second advertisement message (e.g., a second message 32 in FIG. 3) from a second peer device (e.g., device 10-3) containing MVPN membership information for the second peer device. In some illustrative configurations described as an example, processing circuitry 20-2 may receive, from device 10-3, a BGP message 32 containing a MVPN type 1 route as the network layer reachability information. The information in the MVPN type 1 route may include the MVPN membership information for the second peer device. Accordingly, processing circuitry 20-2 may obtain the MVPN peer information 62-2 for the second peer device from the received second advertisement message and store the obtained information 62-2 for the first peer device as part of MVPN membership information 60 for the MVPN instance.

Even after obtaining MVPN membership information 60 usable to instantiate a point-to-multipoint tunnel to the MVPN peers of the MVPN instance, processing circuitry 20-2 may delay the instantiation of the point-to-multipoint tunnel for an indefinite amount of time, until processing circuitry 20-2 determines that such an instantiated point-to-multipoint tunnel will be used to convey multicast traffic.

In the example of FIG. 6, processing circuitry 20-2 may not have received any indication 64 of expected use of the point-to-multipoint tunnel (e.g., may not have received an MVPN type 6 or type 7 route, serving as an indication of expected tunnel use). Accordingly, the corresponding state information 66 for the corresponding point-to-multipoint tunnel may not be generated and the corresponding point-to-multipoint tunnel (which can be generated using MVPN membership information 60) may remain uninstantiated.

In such a manner, only potentially useful point-to-multipoint tunnels are instantiated (e.g., as described in connection with FIGS. 4 and 5), while other potentially unused point-to-multipoint tunnels remain uninstantiated (e.g., as described in connection with FIG. 6).

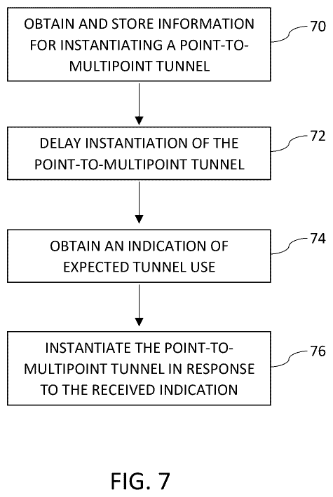

FIG. 7 is a flowchart of illustrative operations for operating one or more network devices, such as network devices 10-1, 10-2, and/or 10-3 as described in connection with FIGS. 1-6. The illustrative operations described in connection with FIG. 7 may be performed by one or more processors (e.g., processing circuitry 20 and/or packet processors 24 in FIG. 2) in a given network device 10 by executing software instructions stored on corresponding memory circuitry 22 (e.g., one or more non-transitory computer-readable media). If desired, one or more operations described in connection with FIG. 7 may be performed by other dedicated hardware components in the given network device 10 and/or by other computing equipment.

At block 70, processing circuitry of a network device may obtain (e.g., receive) and store information for instantiating a point-to-multipoint tunnel. In particular, the information may be MVPN membership information obtained from respective route advertisement messages (e.g., BGP messages containing MVPN type 1 routes) originating from corresponding MVPN peers of a given MVPN instance.

At block 72, the processing circuitry may delay instantiation of the point-to-multipoint tunnel (until reception of an indication of point-to-multipoint tunnel use). In particular, while there may already be sufficient information to instantiate the point-to-multipoint tunnel based on the MVPN membership information of the MVPN peers, instantiating a point-to-multipoint tunnel that will remain unused can unnecessarily consume network resources (e.g., computing resources of MVPN devices that instantiate the tunnel, computing resources of devices that signal the maintenance of the paths that form the tunnel, network traffic bandwidth through the network, etc.). Accordingly, delaying (e.g., holding off on) the instantiation of the point-to-multipoint tunnel until there is an indication that the point-to-multipoint tunnel will be used, increases the likelihood that only useful point-to-multipoint tunnels are instantiated.

At block 74, the processing circuitry may obtain (e.g., receive) an indication of expected, or anticipated, (point-to-multipoint) tunnel use. The obtained indication may be an indication of anticipated conveyance of multicast traffic to at least one MVPN peer of the plurality of MVPN peers for the MVPN instance. As illustrative examples, the indication of anticipated conveyance of multicast traffic to at least the one MVPN peer may be contained within a route advertisement message (e.g., a message containing a tree join route such as a BGP message containing a MVPN type 6 route or a MVPN type 7 route) originating from at least the one MVPN peer.

At block 76, the processing circuitry may instantiate the point-to-multipoint tunnel in response to received indication (and based on the stored information for instantiating the point-to-multipoint tunnel). In particular, based on obtaining the indication of anticipated tunnel use from the received route advertisement message, the processing circuitry may instantiate the point-to-multipoint tunnel by generating state information for implementing the point-to-multipoint tunnel and taking actions to implement the point-to-multipoint tunnel based on the state information (e.g., these actions may be include local configurations or actions causing local configurations on MVPN peers).

The methods and operations described above in connection with FIGS. 1-7 may be performed by the components of one or more network devices and/or other computing equipment using software, firmware, and/or hardware (e.g., dedicated circuitry or hardware). Software code for performing these operations may be stored on one or more non-transitory computer-readable storage media (e.g., tangible computer-readable storage media) stored on one or more of the components of the network device(s) and/or other computing equipment. The software code may sometimes be referred to as software, data, instructions, program instructions, or code. The one or more non-transitory computer readable storage media may include drives, non-volatile memory such as non-volatile random-access memory (NVRAM), removable flash drives or other removable media, other types of random-access memory, etc. Software stored on the one or more non-transitory computer readable storage media may be executed by processing circuitry on the network device(s) and/or other computing equipment (e.g., by respective processing circuitry 20 in one or more network devices 10 in FIGS. 1-7).

The foregoing is merely illustrative and various modifications can be made to the described embodiments. The foregoing embodiments may be implemented individually or in any combination.

What is claimed is:

1. A network device comprising:
memory circuitry; and
processing circuitry coupled to the memory circuitry and configured to:
obtain multicast virtual private network (MVPN) membership information for a plurality of MVPN peer devices;
store the MVPN membership information;
obtain an indication of anticipated conveyance of multicast traffic to a given MVPN peer device of the plurality of MVPN peer devices; and
in response to the received indication, instantiate, based on the stored MVPN membership information, a point-to-multipoint tunnel to the plurality of MVPN peer devices.

2. The network device defined in claim 1, wherein the processing circuitry is configured to receive route advertisement messages from each of the plurality of MVPN peer devices, the route advertisement messages from the plurality of MVPN peer devices respectively containing the MVPN membership information for the plurality of MVPN peer devices.

3. The network device defined in claim 2, wherein the route advertisement messages each contain a border gateway protocol (BGP) MVPN Intra-Autonomous-System (Intra-AS) Inclusive Provider Multicast Service Interface (I-PMSI) Auto-Discovery (A-D) route for a corresponding MVPN peer device in the plurality of MVPN peer devices and wherein the MVPN membership information for the plurality of MVPN peer devices comprises network layer reachability information associated with the BGP MVPN Intra-AS I-PMSI A-D routes.

4. The network device defined in claim 1, wherein the processing circuitry is configured to receive a route advertisement message from the given MVPN peer device, the route advertisement message containing the indication of anticipated conveyance of multicast traffic to the given MVPN peer device.

5. The network device defined in claim 4, wherein the route advertisement message contains a border gateway protocol (BGP) MVPN Shared Tree Join route as the indication of anticipated conveyance of multicast traffic to a given MVPN peer device.

6. The network device defined in claim 5, wherein the network device is configured as a rendezvous point network device for the plurality of MVPN peer devices.

7. The network device defined in claim 4, wherein the route advertisement message contains a border gateway protocol (BGP) MVPN Source Tree Join route as the indication of anticipated conveyance of multicast traffic to a given MVPN peer device.

8. The network device defined in claim 7, wherein the network device is configured as a provider edge network device communicatively coupled to a source host providing traffic conveyed using the point-to-multipoint tunnel.

9. The network device defined in claim 1, wherein the stored MVPN membership information is usable to instantiate the point-to-multipoint tunnel prior to the obtaining of the indication of anticipated conveyance of multicast traffic to the given MVPN peer device and wherein the processing circuitry is configured to delay the instantiation of the point-to-multipoint tunnel until after the indication of anticipated conveyance of multicast traffic to the given MVPN peer device is obtained.

10. The network device defined in claim 1, wherein the plurality of MVPN peer devices comprise a first MVPN peer device and a second MVPN peer device, wherein the processing circuitry is configured to obtain the MVPN membership information from a first advertisement message sent by the first MVPN peer device and from a second advertisement message from the second MVPN peer device, and wherein the processing circuitry is configured to obtain the indication of anticipated conveyance of multicast traffic to a given MVPN peer device from a third advertisement message sent by the first MVPN peer device.

11. The network device defined in claim 1, wherein the processing circuitry is configured to instantiate the point-to-multipoint tunnel to the plurality of MVPN peer devices by generating state information for the point-to-multipoint tunnel and by transmitting, based on the state information, path signaling messages to downstream network devices, including the plurality of MVPN peer devices.

12. The network device defined in claim 11, wherein the path signaling messages comprise resource reservation protocol (RSVP) messages.

13. The network device defined in claim 1, wherein the processing circuitry is configured to instantiate the point-to-multipoint tunnel to the plurality of MVPN peer devices by generating state information for the point-to-multipoint tunnel and by configuring, based on the generated state information, ingress replication at the network device.

14. A method of operating a network device with first and second peer network devices, the method comprising:
obtaining multicast virtual private network (MVPN) membership information for the first and second peer network devices;
storing the obtained MVPN membership information;
delaying instantiation of a point-to-multipoint tunnel from the network device to the first and second peer network devices until reception of an indication of anticipated use of the point-to-multipoint tunnel;
receiving a message from the first peer network device, the message containing the indication of anticipated use of the point-to-multipoint tunnel; and
instantiating the point-to-multipoint tunnel based on receiving the message from the first peer network device.

15. The network device defined in claim 14 further comprising:
receiving a first additional message from the first peer network device; and
receiving a second additional message from the second peer network device, wherein obtaining the MVPN membership information for the first and second peer network devices comprises obtaining MVPN membership information for the first peer network device from the first additional message and obtaining MVPN membership information for the second peer network device from the second additional message.

16. The network device defined in claim 14, wherein the message includes a tree join route that serves as the indication of anticipated use of the point-to-multipoint tunnel.

17. A network device comprising:
memory circuitry; and
processing circuitry coupled to the memory circuitry and configured to:
obtain one or more border gateway protocol (BGP) multicast virtual private network (MVPN) Intra-Autonomous-System (Intra-AS) Inclusive Provider Multicast Service Interface (I-PMSI) Auto-Discovery (A-D) routes from one or more corresponding peer network devices;
obtain a BGP MVPN Customer Multicast (C-Multicast) route from a given one of the one or more peer network devices; and
instantiate a point-to-multipoint tunnel based on the obtained BGP MVPN C-Multicast route and based on the obtained one or more BGP MVPN Intra-AS I-PMSI A-D routes.

18. The network device defined in claim 17, wherein the MVPN C-Multicast route is a BGP MVPN Shared Tree Join route or a BGP MVPN Source Tree Join route.

19. The network device defined in claim 18, wherein the network device is configured as a rendezvous point network device and wherein the MVPN C-Multicast route is the BGP MVPN Shared Tree Join route.

20. The network device defined in claim 18, wherein the network device is configured as a sender provider edge network device and wherein the MVPN C-Multicast route is the BGP MVPN Source Tree Join route.
